(19) United States
(12) Patent Application Publication
(10) Pub. No.: US 2022/0011938 A1
(43) Pub. Date: Jan. 13, 2022

(54) SYSTEM AND METHOD FOR SELECTIVELY RESTORING DATA

(71) Applicant: Druva Inc., Sunnyvale, CA (US)

(72) Inventors: Ajay Potnis, Pune (IN); Milind Vithal Borate, Pune (IN)

(21) Appl. No.: 17/163,554

(22) Filed: Jan. 31, 2021

(30) Foreign Application Priority Data
Jul. 10, 2020 (IN) 202041029261

(51) Int. Cl. G06F 3/06

(52) U.S. Cl. CPC G06F 3/065; G06F 3/067; G06F 3/0619

(57) ABSTRACT

A system for selectively restoring data from a data back-up server is presented. The system includes a data access module configured to access a state_{N} of the data from a primary data source at a point N. The system further includes a log access module configured to access a log of modified meta-data and data blocks (MMDBs), from the primary data source or the data back-up server, corresponding to a data back-up point previous to the point N. The system furthermore includes a data restore module configured to iteratively perform selective restore of the data, based on the state_{N} and the MMDBs, from the data back-up server to a restore destination, until the data is restored to a state_{RP} corresponding to a recovery point (RP), as defined by a user. A related method is also presented.

### PRIORITY STATEMENT

The present application claims priority under 35 U.S.C. § 119 to Indian patent application number 202041029261 filed 10 JUL. 2020, the entire contents of which are hereby incorporated herein by reference.

### BACKGROUND

Embodiments of the present invention generally relate to systems and methods for restoring data from a data back-up server, and more particularly to systems and methods for selectively restoring data from a data back-up server using modified meta-data and data blocks.

Enterprises these days seek reliable, cost-effective ways to protect the data stored on their computer networks while minimizing impact on productivity. An enterprise might back up critical computing systems such as databases, file servers, web servers, virtual machines, and so on as part of a daily, weekly, or monthly maintenance schedule. In the event of data loss, data corruption and/or other disaster-related occurrence, the backed-up data may be restored to the primary data source or another restore destination. However, current methods and systems for data restore may only provide an option for restoring all files and folders, irrespective of whether any changes have been made between the two back-up sessions, i.e., a full restore. Therefore, the current methods and systems for data restore may require a significant amount of restore time and bandwidth utilization. Further, a full data restore may also incur a significant amount of data transfer and bandwidth-related costs.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for selectively restoring data from a data back-up server is presented. The system includes a data access module configured to access a state_{N} of the data from a primary data source at a point N. The system further includes a log access module configured to access a log of modified meta-data and data blocks (MMDBs), from the primary data source or the data back-up server, corresponding to a data back-up point previous to the point N. The system furthermore includes a data restore module configured to iteratively perform selective restore of the data, based on the state_{N} and the MMDBs, from the data back-up server to a restore destination, until the data is restored to a state_{RP} corresponding to a recovery point (RP), as defined by a user.

According to another example embodiment, a system for selectively restoring data from a data back-up server is presented. The system includes a memory storing one or more processor-executable routines and a processor communicatively coupled to the memory. The processor is configured to receive a recovery point (RP) as defined by a user, and access a state_{N} of the data from a primary data source at a point N. The processor is further configured to access a log of modified meta-data and data blocks (MMDB), from the primary data source or the data back-up server, corresponding to a data back-up point previous to the point N. The processor is furthermore configured to iteratively perform selective restore of the data, based on the state_{N} and the MMDB, from the data back-up server to a restore destination, until the data is restored to a state_{RP}, corresponding to the recovery point (RP).

According to another example embodiment, a method for selectively restoring data from a data back-up server is presented. The method includes receiving a recovery point (RP) as defined by a user, and accessing a state_{N} of the data from a primary data source at a point N. The method further includes accessing a log of modified meta-data and data blocks (MMDB), from the primary data source or the data back-up server, corresponding to a data back-up point previous to the point N. The method furthermore includes iteratively performing selective restore of the data, based on the stater and the MMDB, from the data back-up server to a restore destination, until the data is restored to a state_{RP}, corresponding to the recovery point (RP).

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example data back-up and restore system environment, according to some aspects of the present description,

FIG. 2 is a block diagram illustrating an example data restore system, according to some aspects of the present description,

FIG. 3 is a block diagram illustrating an example data restore operation, according to some aspects of the present description,

FIG. 4A is a block diagram illustrating an example incremental data back-up scenario, according to some aspects of the present description,

FIG. 4B is a block diagram illustrating an example incremental data restore scenario, according to some aspects of the present description,

FIG. 5A is a block diagram illustrating an example incremental data back-up scenario, according to some aspects of the present description,

FIG. 5B is a block diagram illustrating an example incremental data restore scenario, according to some aspects of the present description,

FIG. 6 is a block diagram illustrating an example data restore operation, according to some aspects of the present description,

FIG. 7 is a block diagram illustrating an example data restore operation, according to some aspects of the present description,

FIG. 8 is a block diagram illustrating an example data restore operation, according to some aspects of the present description,

FIG. 9A a block diagram illustrating an example data restore system with instant restore, according to some aspects of the present description,

FIG. 9B is a block diagram illustrating an example instant data restore operation, according to some aspects of the present description,

FIG. 10 is a block diagram illustrating an example data restore system, according to some aspects of the present description,

FIG. 11 is a flow chart illustrating a method for selectively restoring data, according to some aspects of the present description,

FIG. 12 is a flow chart illustrating a method for iteratively performing selective date restore, according to some aspects of the present description,

FIG. 13 is a flow chart illustrating a method for instant date restore, according to some aspects of the present description, and

FIG. 14 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for selectively restoring data from a data back-up server. Some embodiments of the present description provide systems and methods for optimally and selectively restoring data from a data back-up server using modified meta-data and data blocks.

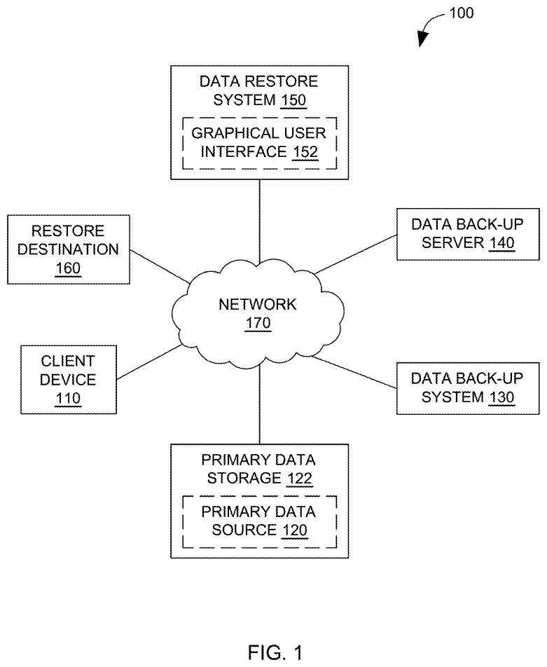

FIG. 1 illustrates an example data back-up and restore system environment 100, in accordance with some embodiments of the present description. The system environment 100 includes a client device 110, a primary data source 120, a primary data storage 122, a data back-up system 130, a data back-up server 140, a data restore system 150, and a restore destination 160.

The system environment 100 may be configured to store back-up data from the primary data source 120 in the data back-up server 140 using the data back-up system 130. Further, the system environment 100 may be configured to restore at least a portion of the back-up data to the restore destination 160 using the data restore system 150. As described in detail later, the primary data source 120 stores data generated by the client device 110, and although the primary data source 120 and the client device 110 are represented as two different blocks, the primary data source 120 may be present in the client device 110 itself. Similarly, although the data restore destination 150 and the client device 110 are represented as two different blocks, in some embodiments, the data restore destination 160 may be present in the client device 110 itself. Further, in some embodiments, a location of the data restore destination 160 may be the same as a location of the primary data source 120.

The client device 110 may be any computing device that has data that may need back-up. Examples of such client devices 110 include without limitation, workstations, personal computers, desktop computers, or other types of generally fixed computing systems such as mainframe computers, servers, and minicomputers. Other examples of such client devices 110 include mobile or portable computing devices, such as one or more laptops, tablet computers, personal data assistants, mobile phones (such as smartphones), IoT devices, wearable electronic devices such as smart watches, and other mobile or portable computing devices such as embedded computers, set top boxes, vehicle-mounted devices, wearable computers, etc. Servers can include mail servers, file servers, database servers, virtual machine servers, and web servers.

In some embodiments, a client device 110 includes cloud computing resources, which may be implemented as virtual machines. For instance, one or more virtual machines may be provided to the organization by a third-party cloud service vendor. In some embodiments, the client device 110 can include one or more virtual machine(s) running on a physical host computing device (or “host machine”) operated by the organization. As one example, the organization may use one virtual machine as a database server and another virtual machine as a mail server, both virtual machines operating on the same host machine. A Virtual machine (“VM”) is a software implementation of a computer that does not physically exist and is instead instantiated in an operating system of a physical computer (or host machine) to enable applications to execute within the VM's environment, i.e., a VM emulates a physical computer. A VM includes an operating system and associated virtual resources, such as computer memory and processor(s). A hypervisor operates between the VM and the hardware of the physical host machine and is generally responsible for creating and running the VMs. Hypervisors are also known in the art as virtual machine monitors or a virtual machine managers or “VMMs”, and may be implemented in software, firmware, and/or specialized hardware installed on the host machine. The hypervisor provides resources to each virtual operating system such as a virtual processor, virtual memory, a virtual network device, and a virtual disk.

It should be noted that although, FIG. 1 only illustrates a single client device, the data back-up and restore system environment 100 may also include a plurality of client devices. In some such embodiments, the clients may be heterogeneous. For example, the clients may be of different types, such as individual end-users, organizations, businesses, webpage providers, servers, and the like. Although clients may be heterogeneous, from the point of view of the data back-up system 130 and the data restore system 150, the plurality of client devices 110 that may need data back-up and restore services may be treated in the same or a similar manner. In some other embodiments, the clients and/or client devices 110 may be of the same type.

The system environment 100 further include a primary data source 120. In some embodiments, the primary data source 120 is located in a primary data storage 122 configured for mass storage of data, The primary data storage 122 may be packaged/configured with the client device 110 (e.g., an internal hard disk) and/or may be external and accessible by the client device 110 (e.g., network-attached storage, a storage array, etc.). Non-limiting examples of primary data storage 122 include, without limitation, disk drives, storage arrays (e.g., storage-area network (SAN) and/or network-attached storage (NAS) technology), semiconductor memory (e.g., solid state storage devices), network attached storage (NAS) devices, tape libraries, or other magnetic, non-tape storage devices, optical media storage devices, or combinations thereof. In some embodiments, the primary data storage 122 may be part of a distributed file system. In some embodiments, the primary data storage 122 is provided in a cloud storage environment (e.g., a private cloud or one operated by a third-party vendor).

As noted earlier, in some embodiments, the client device 110 may include one or more virtual machines operating on a physical host machine. In such embodiments, each virtual machine has one or more associated virtual disks and the primary data storage 122 may include one or more of these virtual disks. The hypervisor typically stores the data of virtual disks in files on the file system of the physical host machine, called virtual machine disk files (“VMDK” in VMware language) or virtual hard disk image files (in Microsoft language). A virtual machine reads data from and writes data to its virtual disk much the way that a physical machine reads data from and writes data to a physical disk.

The primary data storage 122 may be dedicated or shared. In some embodiments, each primary data storage 122 is dedicated to an associated client 110, e.g., a local disk drive. In other embodiments, one or more primary data storages 122 can be shared by multiple client devices 110, e.g., via a local network, in a cloud storage implementation, etc.

According to some embodiments, the client device 110 can access data stored in the primary data source 120 by making conventional file system calls via the operating system. Each client device 110 is generally associated with and/or in communication with one or more primary data source 120 storing data. A client device 110 is said to be associated with or in communication with a particular primary data source 120 if it is capable of one or more of: routing and/or storing data to the primary data source 120, coordinating the routing and/or storing of data to the primary data source 110, retrieving data from the primary data source 120, coordinating the retrieval of data from the primary data source 120, and modifying and/or deleting data in the primary data source 120.

The data present in the primary data source 120 is generally data generated by the operating system and/or applications executing on the client device 110. The data is generally stored on primary data storage 122 and is organized via a file system operating on the client device 110. Non-limiting examples of suitable file systems may include NTFS (Microsoft proprietary file system), VMDK (VMware proprietary file system), and the like. In general, the data present in the primary data source 120 may include files, directories, file system volumes, data blocks, extents, or any other hierarchies or organizations of data objects. As used herein, the term “data object” refers to (i) any file that is currently addressable by a file system or that was previously addressable by the file system (e.g., an archive file), and/or to (ii) a subset of such a file (e.g., a data block, an extent, etc.). The data present in the primary data source 120 may further include structured data (e.g., database files), unstructured data (e.g., documents), and/or semi-structured data.

The primary data source 120 also includes metadata associated with the data present in the primary data source 120. Metadata generally includes information about data objects and/or characteristics associated with the data objects. Metadata can include, without limitation, one or more of the following: the data owner (e.g., the client or user that generates the data), the last modified time (e.g., the time of the most recent modification of the data object), a data object name (e.g., a file name), a data object size (e.g., a number of bytes of data), information about the content (e.g., an indication as to the existence of a particular search term), user-supplied tags, to/from information for email (e.g., an email sender, recipient, etc.), creation date, file type (e.g., format or application type), last accessed time, application type (e.g., type of application that generated the data object), location/network (e.g., a current, past or future location of the data object and network pathways to/from the data object), geographic location (e.g., GPS coordinates), frequency of change (e.g., a period in which the data object is modified), business unit (e.g., a group or department that generates, manages or is otherwise associated with the data object), aging information (e.g., a schedule, such as a time period, in which the data object is migrated to secondary or long term storage), boot sectors, partition layouts, file location within a file folder directory structure, user permissions, owners, groups, access control lists (ACLs), system metadata (e.g., registry information), combinations of the same or other similar information related to the data object. In addition to metadata generated by or related to file systems and operating systems, some applications and/or other components of the client device 110 maintain indices of metadata for data objects, e.g., metadata associated with individual email messages.

The data back-up system 130 may be a software or a hardware component that enables the client device 110 to store and back-up data and search and access the back-up data. The data back-up system 130 may further provide a graphical user interface (not shown) for individual clients to access data-back up server 140 for cloud data management. For example, a graphical user interface may be a front-end cloud storage interface. Additionally, or alternatively, the data back-up system 130 may provide APIs for the access and management of files from the client device 110.

In accordance with certain embodiments of the present invention, the data back-up system 130 is configured to perform incremental data back-up. An incremental data back-up is a type of back-up that copies only data that was changed since the previous back-up. Unlike a full back-up where all data is copied to the back-up storage with every back-up job, after an instance of a full back-up, the incremental approach only allows back up of files that were changed since the most recent backup. Thus, incremental back-up reduces storage requirements, bandwidth load, and provides the necessary level of data consistency and availability. In certain embodiments, the data back-up system 130 is configured to perform incremental data back-up based on modified meta-data and data blocks (MMDB). The term “modified meta-data and data blocks” as used herein refers to blocks of meta-data and/or data that have been added, deleted or changed since the last data back-up point. A log of the modified meta-data and data blocks, i.e., log of MMDBs may be further stored in the primary data source 120 and/or the data back-up server 140 by the data back-up system 130, as further described in detail later. These logs are typically referred to as CBT (Change Block Tracking) logs in VMware file systems and change journal records in Microsoft NTFS file systems.

The back-up schedule for the client device 110 may be installed with a client utility application or configured within the host operating system (OS), using the data back-up system 120. At the scheduled time, the client device 110 may connect with the data back-up server 140 via the data back-up system 130 to initiate the data back-up process. (either full or incremental). For example, the first instance of data backup may involve a full backup of the data from the primary data source 120 to the data back-up server 140, followed by incremental back-ups depending on the back-up schedule.

The data back-up server 140 may combine hardware and software technologies that provide back-up storage and retrieval services to the client device 110 via the data back-up system 130. In some embodiments, the data back-up server 140 is a cloud-based storage. The back-up data from the primary data source 120 may be stored and backed-up in an object-based storage, a file-based storage, or a block-based storage. In some embodiments, the back-up data is stored in a block-based storage. Non-limiting examples of suitable data storage 120 include AWS Elastic Block storage, GOOGLE CLOUD Persistent Disks, RACKSPACE Cloud Block Storage, and the like.

As noted earlier, in the event of data loss, data corruption and/or other disaster-related occurrence, it may be desirable to restore the data from the data back-up server 140. The back-up data may be retrieved or restored using the data restore system 150 in the data back-up and restore system environment 100. The data restore system 150 may be a software or a hardware component that enables the client to restore and access the back-up data. The data restore system 150 may optionally further provide a graphical user interface 152 for individual clients to access and manage the data restored. Additionally, or alternatively, the data restore system 150 may provide APIs for the access and management of files to the be restored.

The data restore system 150, as described in detail later, is configured to optimally and selectively restore data from the data back-up server 140. The term “selectively restore” as used herein means that the data restore system 150 is configured to restore only modified data blocks or files from the data back-up server 140. The term “modified data blocks or files” as used herein refers to data blocks or files that have been added, changed or deleted after a particular back-up point. The data restore system 150 is further configured to retrieve or use the unmodified data blocks or files from the primary data source 120 while performing the data restore operation. Thus, the data restore operation in accordance with embodiments of the present description is implemented by using or retrieving unmodified data blocks or files from the primary data source 120 in combination with restoring only the modified data blocks or files from data back-up server 140. The individual components of the data restore system 150 and their respective functions are described in detail below.

The data back-up and restore system environment 100 further includes a restore destination 160. The restore destination 160 may be located at the same location as the primary data source 120, in some embodiments. In such instances, for example, the data restore system 150 may be configured to overwrite the data on the primary data source 120 to restore the data to a particular point. In such instances, although the data restore destination 150 and the primary data source and/or primary data storage 122 are shown as different blocks, the block representing the data restore destination 160 may be the same as the block representing the primary data source 120. Further, in embodiments where the primary data storage 122 is a storage system internal to the client device 110, the blocks representing the primary data source 120, the primary data storage 122, and the destination location 160 may be present in the client device 110 itself.

In some other embodiments, the restore destination 160 may be located at a location different from the primary data source 120. In some such instances, the restore destination 160 may be at different location in the primary data storage 122 itself, and the data restore system 150 may be configured to create a clone of the data on the restore destination 160. For example, the restore destination 160 could be a completely new instance to which a VMDK is attached. In such instances, the data restore destination 150 and the primary data source 120 may be shown as different blocks located in the primary data storage 122. Further, in embodiments where the primary data storage 122 is a storage system internal to the client device 110, the blocks representing the primary data source 120, the primary data storage 122, and the destination location 160 may be present in the client device 110 itself.

In some other instances, the restore destination 160 may be located in a secondary data storage (not shown in FIGs.) and the data restore system 150 may be configured to create a clone of the data on the restore destination 160. The secondary data storage may be packaged/configured with the client device 110 (e.g., an internal hard disk) and/or may be external and accessible by the client device110 (e.g., network-attached storage, a storage array, etc.). Non-limiting examples of secondary data storage include, without limitation, disk drives, storage arrays (e.g., storage-area network (SAN) and/or network-attached storage (NAS) technology), semiconductor memory (e.g., solid state storage devices), network attached storage (NAS) devices, tape libraries, or other magnetic, non-tape storage devices, optical media storage devices, or combinations thereof. In some embodiments, the secondary data storage is provided in a cloud storage environment (e.g., a private cloud or one operated by a third-party vendor). In such instances, the data restore destination 150 and the primary data source 120 may be shown as different blocks located in primary data storage 122 and secondary data storage, respectively. Further, in embodiments where the primary data storage 122 and the secondary data storage are internal to the client device 110, the blocks representing the primary data source 120, the primary data storage 122, the secondary data storage, and the destination location 160 may be present in the client device 110 itself.

The various components in the system environment 100 may communicate through the network 170 and/or locally. For example, in some embodiments, one of the system components may communicate locally with the data back-up system 130, while other components communicate with the data back-up system 130 through the networks. In other embodiments, every component in the system environment 100 is online and communicates with each other through the network 170. In one embodiment, the network 170 uses standard communications technologies and/or protocols. Thus, the network 170 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 170 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

While the components of the system environment 100 are each represented by a single block in FIG. 1, each of these components may include multiple distributed and/or independent computers (may also be referred to as workers) working cooperatively and in parallel with other computers so that the operation of the entire system will not be affected when one or more workers are down.

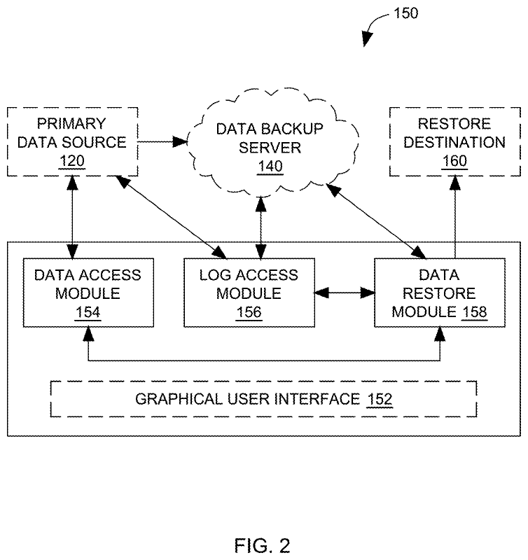

FIG. 2 is a block diagram of a data restore system 150 for selectively restoring data from a data back-up server, in accordance with some embodiments of the present description. The data restore system 150 includes an optional graphical user interface 152. The data restore system 150 further includes a data access module 152, a log access module 156 and a data restore module 156. Each of these system components are in data communication with one or more of the primary data source 120, the data back-up server 140, and the restore destination 160.

The data restore process may be initiated by the data restore system 150 based on a command from a user e.g., via the graphical user interface 152 or an API. The user may further define a recovery point (RP) to which the data needs to be restored. The state of the restored data corresponding to the recovery point (RP) is referred to as stateRP. In some embodiments, the recovery point (RP) may correspond to one of the data back-up points of the incremental back-up implemented by the data back-up system 130 of FIG. 1. Once the data restore process is initiated, the data restore system may execute one or more data restore sub-routines using the data access module 154, the log access module 156, and the data restore module 158. These system components are described in further detail below.

The data access module 154 is communicatively coupled to the primary data source 120 and configured to access a stateN of the data from the primary data source 120 at a point N. The term “stateN” as used herein refers to both the original data blocks or files as well as the snapshot of the data blocks or files at the point N. The term “point N” as used herein refers to either the current point in time at which the restore process is initiated or one of the data back-up points when the incremental back-up was implemented by the data back-up system 130 of FIG. 1. In some embodiments, stateN corresponds to the current state of the data on the primary data source 120. In another embodiment, the stateN corresponds to a state closest to the stateRP and is different from a current state of the data on the primary data source 120. As shown in FIG. 2, the data access module 154 is further communicatively coupled to the data restore module 158, and provides the stateN of the data to the data restore module 158.

The log access module 156 is communicatively coupled to both the primary data source 120 and the data back-up server 130. The log access module 156 is configured to access a log of modified meta-data and data blocks (MMDBs) from the primary data source 120 or the data back-up server 130. As mentioned earlier, modified data blocks or files include data blocks or files that have been added, changed or deleted after a particular back-up point. During an incremental back-up by the data back-up system 130, a log of the modified meta-data and data blocks is generated between the two data back-up points, and includes information corresponding to the data blocks or files that that have been added, changed or deleted between the two back-up points. The log of the MMDBs is stored in the data back-up server 140 along with the data that is backed up in the data back-up server. These logs are typically referred to as CBT (Change Block Tracking) logs in VMware file systems and change journal records in Microsoft NTFS file systems. The log of the MMDBs may be further stored in the primary data source 120 in addition to the data back-up server 140, in some embodiments.

The log access module is configured to access the log of MMDBs corresponding to a data back-up point previous to the point N. As noted earlier, the point N may correspond to either the current point in time at which the restore process is initiated or one of the data back-up points when the incremental back-up was implemented by the data back-up system 130 of FIG. 1. Thus, the log access module is configured to access the log of MMDBs corresponding to point N-1 which may be either the latest data back-up point, or a data back-up point previous to the data back-up point N. MMDBs corresponding to point N-1 are represented by MMDBN-1 in the present description. Similarly, the log access module 156 is configured to iteratively access the logs of MMDBN-2, MMDBN-3, . . . etc. from the primary data source 120 or the data back-up server 130, until the desired restore state (stateRP) is reached.

In some embodiments, the log access module 156 is configured to first attempt to access the log of MMDBs from the primary data source 120, and if the log of MMDBs is not available on the primary data source 120, the log access module 156 is further configured to access the log of MMDBs from the data back-up server 140. Thus, by first attempting to access the log of MMDBs from the primary data source 120, the total restore time may be reduced.

As mentioned earlier, the data restore system 150 is configured to selectively restore the data from the data back-up server 140 to the restore destination 160 based on the logs of modified meta-data and data blocks (MMDBs) that are stored in the primary data source 120 and/or the data back-up server 140. The log access module 156, as shown in FIG. 2, is also communicatively coupled to the data restore module 158, and provides the logs of MMDBs to the data restore module 158.

With continued reference to FIG. 2, the data restore module 158 is configured to iteratively perform selective restore of the data, based on the stateN and the MMDBs, from the data back-up server 140 to the restore destination 160, until the data is restored to the stateRP corresponding to the recovery point (RP), as defined by the user.

The restore destination 160 may be at the same location as the primary data source 120, or at a different location from the primary data source 120. The restore destination 160 may be located at the same location as the primary data source 120, in some embodiments. In such instances, for example, the data restore module 158 may be configured to overwrite the data on the primary data source 120 to restore the data to stateRP. In some other embodiments, the restore destination 160 may be located at a location different from the primary data source 120 (either on the same data storage or a different data storage altogether), and the data restore module 158 may be configured to create a clone of the data on the restore destination 160 such that the data is restored to stateRP.

In accordance with embodiments of the present description, the data restore module 158 is configured to perform selective restore of the data, i.e., the data restore module is configured to restore only modified data blocks or files from the data back-up server 140. The data restore module 158 is further configured to retrieve or use the unmodified data blocks or files from the primary data source 120 while performing the data restore operation. In some embodiments, the data restore module 158 may access the unmodified data blocks or files from the primary data source 120, via the data access module 152, as shown in FIG. 2. Thus, the data restore operation in accordance with embodiments of the present description is implemented by using or retrieving unmodified data blocks or files from the primary data source 120 in combination with restoring only the modified data blocks or files from data back-up server 140.

Selective and optimal restoration of data can reduce the restore time significantly as only the modified data and data blocks are restored from the data back-up server (e.g., cloud). This may also reduce the amount of data transferred and thus significantly reduce the cost of restoring data from the cloud and the network bandwidth utilized during restore.

Further, in some embodiments, the data restore module 158 is configured to iteratively perform the restore operation from the stateN to the stateRP based on the MMDBs tracked and logged at the different back-up points between the stateN and the stateRP. Thus, the data restore module is configured to perform incremental restore of the data from the data back-up server 140 to the restore destination 160.

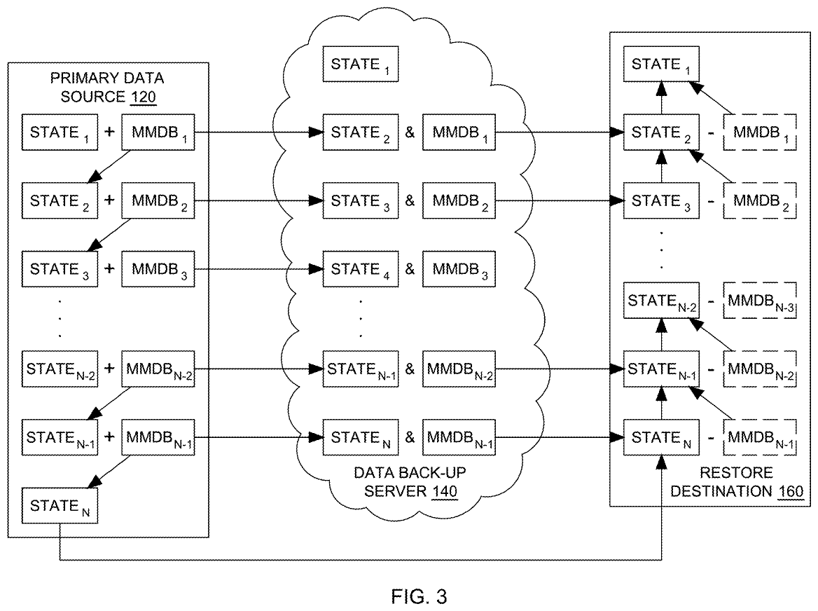

FIG. 3 is a block diagram of an example data restore operation that illustrates the iterative and selective aspects of the data restore systems and methods, in accordance with embodiments of the present description. These aspects are further described in detail below with reference to both FIGS. 2 and 3.

As mentioned earlier, the data from the primary data source 120 is backed up in an incremental manner from the primary data source 120 to the back-up server 140. FIG. 3 illustrates an example back-up process where the data is backed up from state1 to the state N-1 in the data back-up server 140 in an incremental manner. As noted previously, unlike a full back-up where all data is copied to the back-up storage with every back-up job, after an instance of a full back-up, the incremental approach only allows back up of files that were changed since the most recent backup. As shown in FIG. 3, a full back-up corresponding to the state of the data in the primary source 120 at the start of the incremental back-up process is stored as state1 in the data back-up server. Following which, incremental back-up is implemented at back-up points 2, 3, . . . N-1. The incremental changes in the metadata and data blocks (MMDB1, MMDB2, . . . MMDBN-1) between the different back-up points are further stored in the primary data source 120 and the data back-up server 140. Here, by way of examples MMDB1 refers to the meta-data and data blocks that have been modified between the state1 and the state2. Similarly, MMDBN-1 refers to the meta-data and data blocks that have been modified between the stateN-1 and the stateN. A log of the MMDBs is also stored in the data source 120 and the data back-up server 140.

FIG. 3 further illustrates the incremental and selective data restore process in the destination location 160. The data restore process starts from stateN on the destination location 160. As mentioned earlier, with reference to FIG. 2, the data access module 152 is configured to access stateN of the data from the primary data source 120 and provide it to the data restore module 158. The data restore module 158 is configured to either copy the stateN to the destination location 160 (if the destination location 160 is different from the primary data source 120) or restore the destination location 160 to the stateN (if the destination location 160 is same as the primary data source 120). It should be noted that in instances where stateN is the current state of data on the primary data source 120 and the restore destination 160 is the same as the primary data source 120, copying of stateN and/or restoring the destination location to state_{N} may not be required as the stateN is already present in the destination location 160.

The data back-up process further includes selectively restoring the data to stateN-1 at the destination location 160 using the modified meta-data and data blocks from the data back-up point N-1. As mentioned earlier, with reference to FIG. 2, the log access module 156 accesses the log of MMDBN-1 corresponding to a data back-up point N-1 from either the primary data source 120 or the data back-up server 140 and provides it to the data back-up module 158. The data back-up module identifies the blocks and/or files modified based on the log of MMDBN-1 and restores the stateN to stateN-1 based on the MMDBN-1. The log of MMDBN-1 provides the details of data blocks and/or files that have been modified between data back-up point N-1 and the point N.

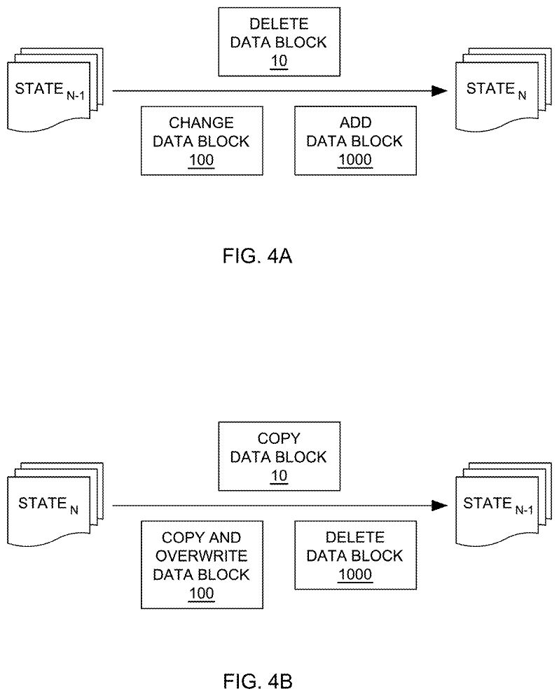

FIG. 4A illustrates an example scenario in which only data blocks 10, 100 and 1000 have been modified from the back-up point N-1 to the point N. In the scenario illustrated in FIG. 4A, the data block 10 is deleted, the data block 100 is changed and the data block 1000 is added between data back-up point N-1 and the point N. These modifications are logged in the log of MMDBN-1. The data restore module 158 in this example scenario therefore determines that only the data blocks 10, 100 and 1000 are modified, and selectively restores the modified blocks 10, 100 and 1000 from the data back-up server 140 to the destination location 160.

The remaining unmodified blocks are taken from stateN that has been accessed directly from the primary data source 120. Thus, the data restore module 150 selectively restores the data to the stateN-1 by using or retrieving unmodified data blocks or files from the primary data source 120 in combination with restoring only the modified data blocks or files from data back-up server 140. This is further illustrated in FIG. 4B, where block 10 from stateN-1 in the back-up server 140 is copied to the stateN present in the destination location 160, the data block 100 from stateN-1 in the back-up server 140 is copied and overwritten on the data block 100 of stateN present in the destination location, and block 1000 is deleted from the stateN, thereby restoring the data to stateN-1.

Referring again to FIGS. 2 and 3, the selective restore of the data by the data restore module 158 is repeated from stateN-1 to stateN-2 in the destination location, by selectively restoring the data blocks that have been modified from the data back-up point N-2 to N-1, based on the log of MMDBN-2. In this instance, the log access module 156 accesses the log of MMDBN-2 corresponding to a data back-up point N-2 from either the primary data source 120 or the data back-up server 140 and provides it to the data back-up module 158. The log of MMDBN-2 provides the details of data blacks and/or files that have been modified between data back-up point N-2 and the point N-1. The data back-up module 158 identifies the blocks and/or files modified based on the log of MMDBN-2 and restores the stateN-1 to stateN-2 based on the MMDBN-2.

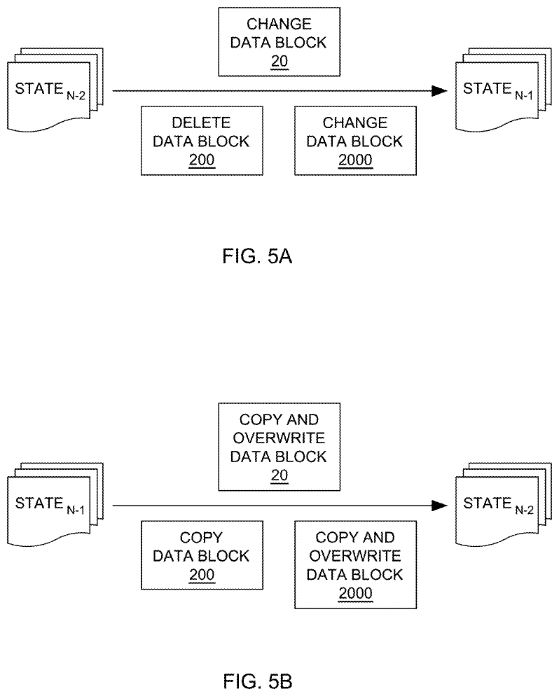

FIG. 5A illustrates an example scenario in which only data blocks 20, 200 and 2000 have been modified from the back-up point N-2 to the point N-1. In the scenario illustrated in FIG. 5A, the data block 20 is changed, the data block 200 is deleted and the data block 2000 is also changed between data back-up point N-2 and the point N-1. These modifications are logged in the log of MMDBN-2. The data restore module 158 in this example scenario therefore determines that only the data blocks 20, 200 and 2000 are modified, and selectively restores the modified blocks 20, 200 and 2000 from the data back-up server 140 to the destination location 160.

The remaining unmodified blocks are taken from stateN-1 that was restored in the previous restore step from stateN to stateN-1. Thus, the data restore module 150 selectively restores the data to the stateN-2 by using or retrieving unmodified data blocks from stateN-1 in combination with restoring only the modified data blocks or files from data back-up server 140. This is further illustrated in FIG. 5B, where block 20 from stateN-2 in the back-up server 140 is copied and overwritten on the data block 200 of stateN-1 present in the destination location 160, the data block 100 from stateN-2 in the back-up server 140 is copied to the stateN-1 present in the destination location 160, and block 2000 from stateN-2 in the back-up server 140 is copied and overwritten on the data block 2000 of stateN-1 present in the destination location 160, thereby selectively restoring the data to stateN-2.

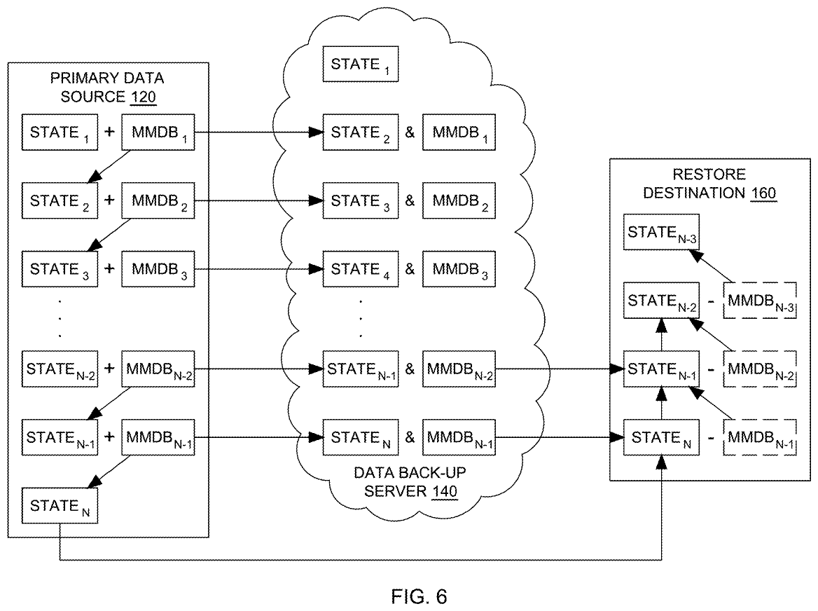

As shown in FIG. 3, the data restore module 158 continues to iteratively selectively restore data from the data back-up server 140 to the restore destination 160 until the stateRP corresponding to the recovery point (RP) defined by the user is reached. FIG. 3 illustrates an example restore operation, where state1 corresponds to stateRP. In such instances, the data back-up server may continue to iteratively selectively restore data until state1 is reached. However, as noted earlier, RP may correspond to any of the data back-up points in the data back-up history. FIG. 6 illustrates another example where the recovery point (RP) set by the user may correspond to N-3 data back-up point, and the data restore process may be completed once the stateN-3 is reached. In this example, stateRP=stateN-3. Thus, according to embodiments of the present description, the restore operation can be implemented for any data back-up point.

In some embodiments, stateN may correspond to the current state of the data of the data on the primary data source 120. In such embodiments, the data restore module 158 is configured to sequentially restore the data to the stateRP, based on the current state and the MMDBs corresponding to different back-up points between the recovery point and the current state. This is further illustrated in FIGS. 3 and 6, as described herein earlier.

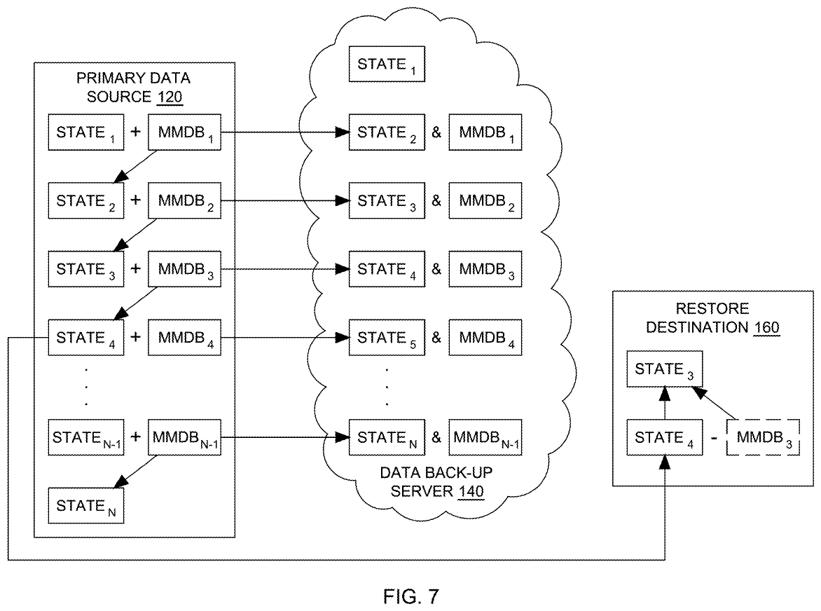

In some other embodiments, the stateN may correspond to a state different from the current state and is the state closest to the recovery point, as defined by the user. By way of example, if the user defines data back-up point 3 as the recovery point, then the stateN may correspond to state4 of the data in the primary data source 120. In such instances, the data access module 154 in the data restore system of FIG. 2 may be configured to directly access and provide state4 to the data restore module 158, which in turn may selectively restore state4 to state3 based on the MMDB3. Since the stateN here corresponds to state4, the data restore module 158 needs to first bring the destination location 160 to state4 before initiating the process of data restore. This is further illustrated in FIG. 7.

In certain instances, some of the data/states may be lost on the primary data source 120 or the data/states may be compacted on the data back-up server 140. The systems and techniques of the present description allow for selective restore of data to the destination location even in such scenarios. In such embodiments, the stateN corresponds to a state closest to the stateRP and is different from a current state of the data on the primary data source. Further, the data restore module 158 is configured to sequentially restore the data to the stateRP, based on a snapshotN corresponding to the stateN and the MMDBs corresponding to different back-up points between the recovery point and the point N.

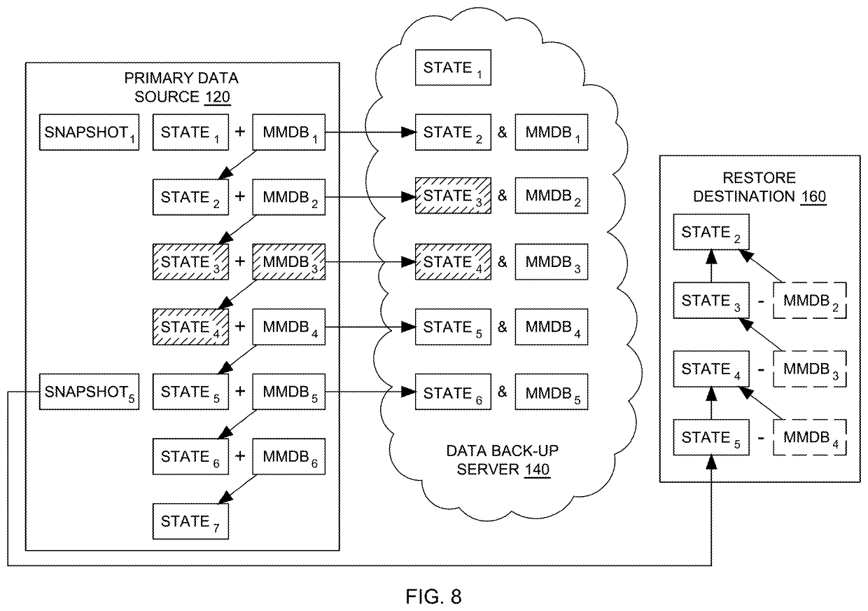

FIG. 8 further illustrates the incremental and selective data restore process for instances where states may be deleted on the primary data source 120 and/or compacted on the data back-up server 140. In the embodiment illustrated in FIG. 8, the restore point (RP) is set as data back-up point 2 by the user, and therefore the desired stateRP is state2. As shown in FIG. 8 (using greyed out boxes), some of the states as well as MMDBs are not present in the primary data source 120 and/or the data back-up server 140. This could be either because the data is deleted (e.g., in the primary data source 120) and/or compacted (e.g., in the data back-ups server 140). Further, some the MMDB logs are also not available int the primary data source 120. The incremental and selective data restore process according to embodiments of the present description is further described herein with reference to FIGS. 2 and 8.

As mentioned earlier, with reference to FIG. 2, the data access module 152 is configured to access stateN of the data from the primary data source 120 and provide it to the data restore module 158. In the example embodiment, illustrated in FIG. 2, the data access module 152 is configured to access a snapshot of the state closest to the state2 (which is stateRP) that is available (i.e., not deleted) on the primary data source 120. As shown in FIG. 2, because states 3 and 4 are deleted, the data access module 152 is configured to access the snapshot of the state5 and provide it to the data restore module 158. The data restore module 158 is configured to either copy the snapshot of state5 to the destination location 160 (if the destination location 160 is different from the primary data source 120) or restore the destination location 160 to the state5 (if the destination location 160 is different from the primary data source 120).

The data back-up process further includes selectively restoring the data to state4 at the destination location 160 using the modified meta-data and data blocks from the data back-up point 4. As mentioned earlier, with reference to FIG. 2, the log access module 156 accesses the log of MMDB corresponding to a particular data back-up point from the primary data source 120 source, and if the log of MMDB is not available on the primary data source 120 it accesses the log of MMDB from the data back-up server 140. In the example embodiment illustrated in FIG. 8, as the MMDB4 is present in the primary data source 120, the log access module 156 accesses the log of MMDB4 from the primary data source 120 and provides it to the data back-up module 158. The data back-up module 158 identifies the blocks and/or files modified based on the log of MMDB4 and selectively restores the state5 to state4 based on the MMDB4, as described in detail earlier. In the next iteration, as the MMDB3 is deleted in the primary data source 120, the log access module 156 accesses the log of MMDB3 from the data back-up server 140 and provides it to the data back-up module 158. The data back-up module 158 identifies the blocks and/or files modified based on the log of MMDB3 and selectively restores the state4 to state3. Furthermore, in the final iteration, the log of MMDB2 is accessed from the primary data source 120 (as its still available) and the data back-up module 158 selectively restores the state3 to state2. Thus, embodiments of the present description allow for selective restore of data in an incremental manner even when the intermediate states and/or MMDBs have been deleted and/or compacted. Thereby, enabling efficient and optimized data restore and minimizing the time and cost for data restore.

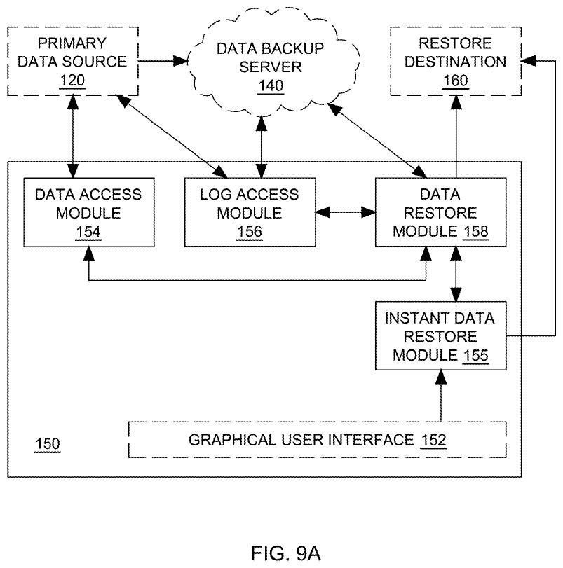

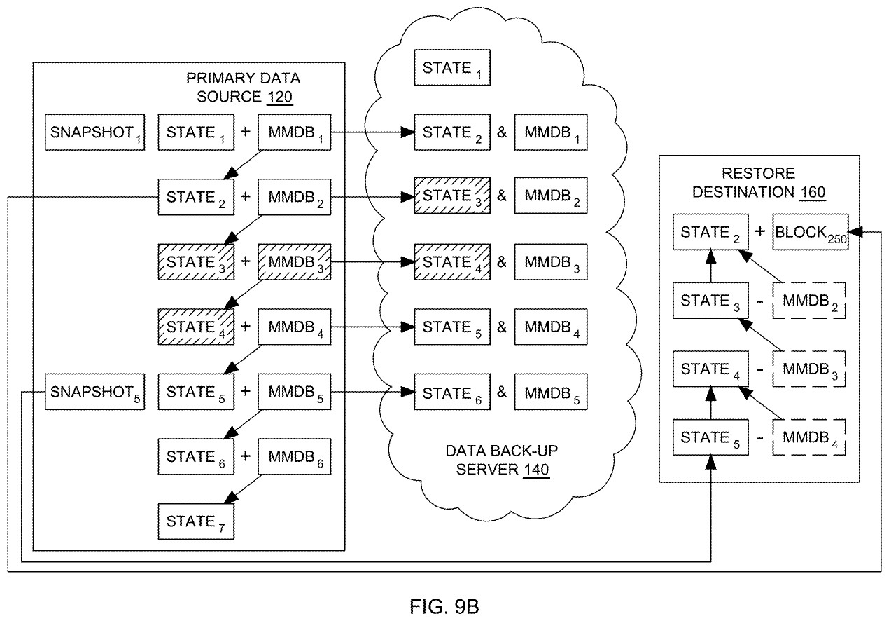

In some embodiments, the systems and methods as described herein provide for instant data restore of data and data blocks to the destination location 160. This is further illustrated using FIGS. 9A & 9B. In such embodiments, as shown in FIG. 9A, the data restore system 150 further includes an instant data restore module 155. The instant restore module 155 is configured to copy top directory metadata corresponding to the stateRP to the restore destination 160. This may enable the file system to be mounted, e.g., in a VMDK system and the VMDK may be used to start the VM.

The instant restore module is further configured to receive a request from the user, based on a search on the copied top directory metadata in the restore destination 160. By way of example, the user may search the top-level directory metadata in the destination location 160 via the graphical user interface 152 or any suitable API. The search may correspond to one or more particular data blocks. In the embodiment illustrated in FIG. 9B, for example, the user may search for the data block 250.

The instant data restore module 155 is furthermore configured to prioritize restoration of the particular data block (e.g., data block 250) on the restore destination 160. In the embodiment illustrated in FIG. 9B, the block 250 may be directly brought from the state2 on the primary data source 120. In some such instances, the copied blocks may be further marked as copied so that they are not copied again during the data restore process. The instant restore process may be implemented before initiating the data restore process as described earlier in FIGS. 3-8, or while the data restore process is in progress.

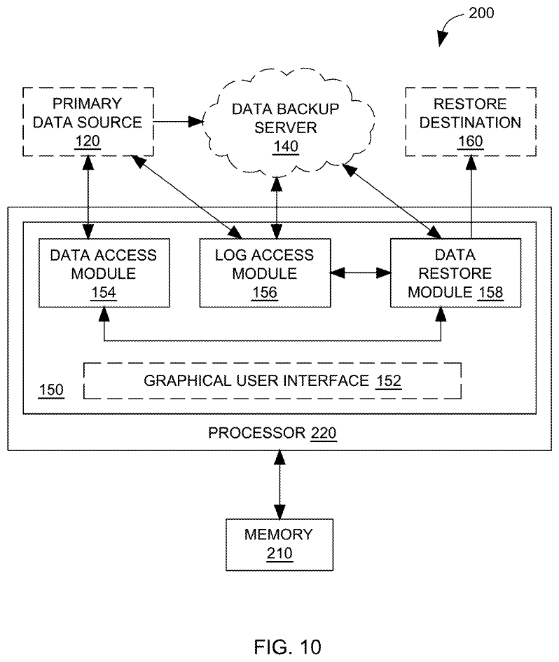

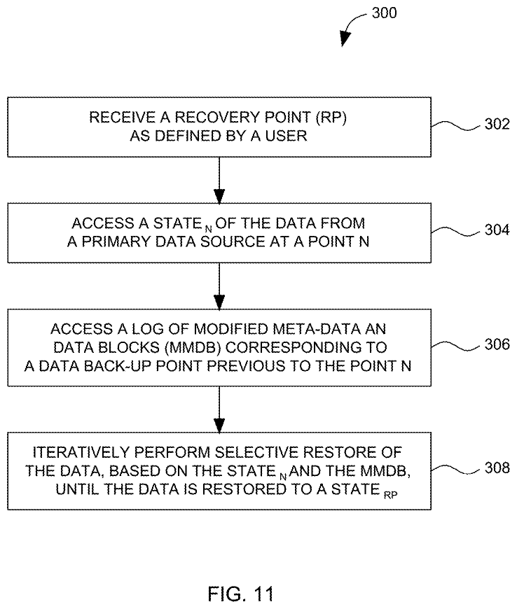

Referring now to FIG. 10, a system 200, according to one embodiment, for selectively restoring data from a data back-up server is presented. The system 200 includes a memory 210 storing one or more processor-executable routines and a processor 220 communicatively coupled to the memory. The system optionally further includes a primary data source 120, a data back-up server 140 and a destination location 160. The processor 220 further includes a data restore system 150, which includes a data access module 154, a log access module 156, and a data restore module 158. Each of these components is described in detail earlier. The processor 220 is further configured to execute the processor-executable routines to perform the steps illustrated in the flow-charts of FIGS. 11-13. It should be noted that the present description encompasses embodiments including a single processor as well as multiple processors.

FIG. 11 is a flowchart illustrating a method 300 for selectively restoring data from a data back-up server. The method 300 may be implemented using the system of FIG. 2, according to some aspects of the present description. Each step of the method 300 is described in detail below.

At block 302, the method 300 includes receiving a recovery point (RP) as defined by a user. In some embodiments, the recovery point (RP) may correspond to one of the data back-up points of the incremental back-up implemented by the data back-up system 130 of FIG. 1. The method further includes, at block 304, accessing a stateN of the data from a primary data source at a point N. In some embodiments, stateN corresponds to the current state of the data on the primary data source. In another embodiment, the stateN corresponds to a state closest to the stateRP and is different from a current state of the data on the primary data source.

At block 306, the method 300 includes accessing a log of modified meta-data and data blocks (MMDB), from the primary data source or the data back-up server, corresponding to a data back-up point previous to the point N. As noted earlier, the point N may correspond to either the current point in time at which the restore process is initiated or one of the data back-up points when the incremental back-up was implemented by the data back-up system 130 of FIG. 1. Thus, block 306 includes accessing the log of MMDBs corresponding to point N-1 which may be either the latest data back-up point, or a data back-up point previous to the data back-up point N. In some embodiments, block 306 includes first attempting to access the log of MMDBs from the primary data source, and if the log of MMDBs is not available on the primary data source, accessing the log of MMDBs from the data back-up server. Thus, by first attempting to access the log of MMDBs from the primary data source, the total restore time may be reduced.

The method 300 further includes, at block 308, iteratively performing selective restore of the data, based on the stateN and the MMDBs, from the data back-up server to a restore destination, until the data is restored to a stateRP, corresponding to the recovery point (RP). As mentioned earlier, the restore destination may be at the same location as the primary data source, or at a different location from the primary data source.

In some embodiments, the method 300 includes sequentially restoring the data to the stateRP, based on the current state and the MMDBs corresponding to different back-up points between the recovery point and the current state. In some other embodiments, the method 300 includes sequentially restoring the data to the stateRP, based on a snapshotN corresponding to the stateN and the MMDBs corresponding to different back-up points between the recovery point and the point N. In such embodiments, the stateN corresponds to a state closest to the stateRP to which the data needs to be restored and is different from the current state.

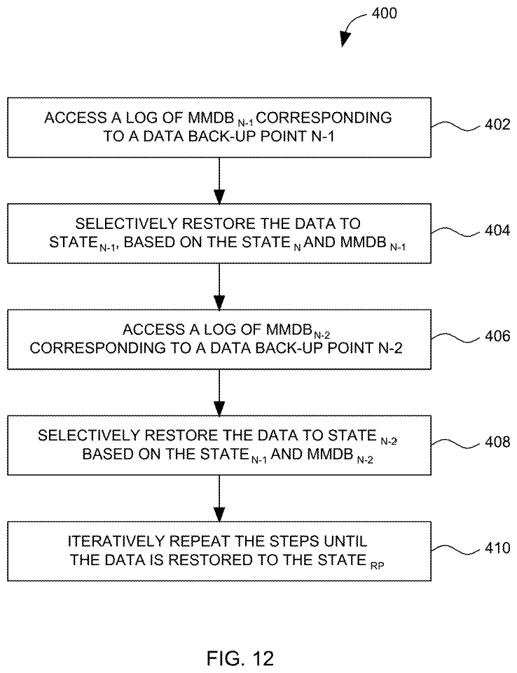

FIG. 12 is a flowchart illustrating a method 400 for iteratively performing selective restore of the data. At block 402, the method includes the step (i) of accessing a log of modified meta-data and data blocks (MMDBN-1), corresponding to a data back-up point N-1, from the primary data source or the data back-up server. At block 404, the method includes the step (ii) of selectively restoring the data to stateN-1, based on the stateN and MMDBN-1, from the data back-up server to the restore destination. Further, at block 406, the method includes the step (iii) of accessing a log of modified meta-data and data blocks (MMDBN-2), corresponding to a data back-up point N-2, from the primary data source or the data back-up server. At block 408, the method includes the step (iv) of selectively restoring the data to stateN-2, based on the stateN-1 and MMDBN-2, from the data back-up server to the restore destination. Further, at block 410, the method includes repeating steps (iii) and (iv) until the data is restored to the stateRP, corresponding to the recovery point (RP), to the restore destination.

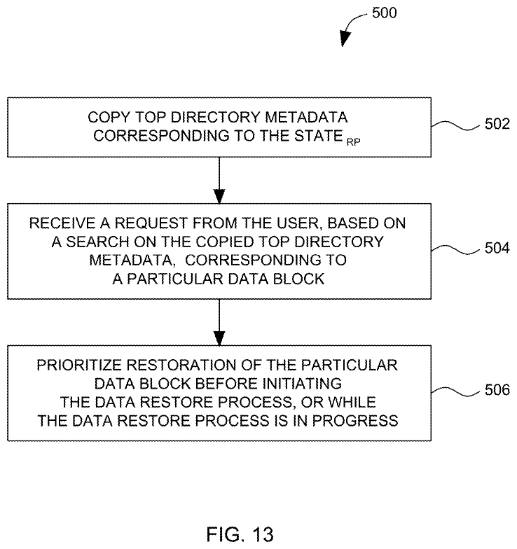

In some embodiments, the methods as described herein provide for instant data restore of data and data blocks to the destination location. FIG. 13 is a flowchart illustrating a method 500 for instant data restore. The method 500 may be implemented using the system of FIG. 9A, according to some aspects of the present description. Each step of the method 500 is described in detail below.

At block 502, the method 500 includes copying the top directory metadata corresponding to the stateRP to the restore destination. At block 504, the method includes receiving a request from the user, based on a search on the copied top directory metadata in the restore destination, corresponding to a particular data block. Further, at block 506, the method includes prioritizing restoration of the particular data block on the restore destination, before initiating the data restore process, or while the data restore process is in progress.

The systems and methods, according to embodiments of the description allow for incremental and selective restore of data from the back-up server instead of a full restore. Selective restoration of data can reduce the restore time significantly as only the modified data and data blocks are restored from the data back-up server (e.g., cloud). This may also reduce the amount of data transferred and thus significantly reduce the cost of restoring data from the cloud and the network bandwidth utilized during restore. Further, as the restore process is implemented iteratively using MMDBs, the restore operation can be implemented for any data back-up point. The systems and methods, according to embodiments of the description allow for the data to be restored on the source as well as a new destination. Furthermore, instant restore of the data on the destination location may be implemented using the methods and systems described herein.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

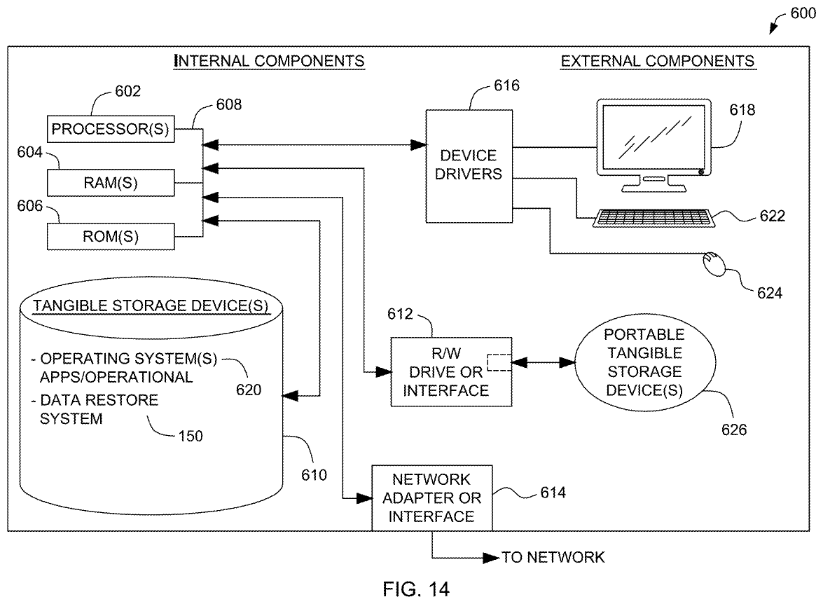

One example of a computing system 600 is described below in FIG. 14. The computing system 600 includes one or more processor 602, one or more computer-readable RAMs 604 and one or more computer-readable ROMs 606 on one or more buses 608. Further, the computer system 608 includes a tangible storage device 610 that may be used to execute operating systems 620 and data restore system 150. Both, the operating system 620 and the data restore system 150 are executed by processor 602 via one or more respective RAMs 604 (which typically includes cache memory). The execution of the operating system 620 and/or the data restore system 150 by the processor 602, configures the processor 602 as a special-purpose processor configured to carry out the functionalities of the operation system 620 and/or the data restore system 150, as described above.

Examples of storage devices 610 include semiconductor storage devices such as ROM 506, EPROM, flash memory or any other computer-readable tangible storage device that may store a computer program and digital information.

Computing system 600 also includes a R/W drive or interface 612 to read from and write to one or more portable computer-readable tangible storage devices 626 such as a CD-ROM, DVD, memory stick or semiconductor storage device. Further, network adapters or interfaces 614 such as a TCP/IP adapter cards, wireless Wi-Fi interface cards, or 3G or 4G wireless interface cards or other wired or wireless communication links are also included in the computing system 600.

In one example embodiment, the data restore system 150 may be stored in tangible storage device 610 and may be downloaded from an external computer via a network (for example, the Internet, a local area network or another wide area network) and network adapter or interface 614.

Computing system 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for selectively restoring data from a data back-up server, the system comprising:
a data access module configured to access a state_{N} of the data from a primary data source at a point N;
a log access module configured to access a log of modified meta-data and data blocks (MMDBs), from the primary data source or the data back-up server, corresponding to a data back-up point previous to the point N; and
a data restore module configured to iteratively perform selective restore of the data, based on the state_{N} and the MMDBs, from the data back-up server to a restore destination, until the data is restored to a state_{RP} corresponding to a recovery point (RP), as defined by a user.

2. The system of claim 1, further comprising an instant data restore module configured to:
copy top directory metadata corresponding to the state_{RP} to the restore destination,
receive a request from the user, based on a search on the copied top directory metadata in the restore destination, corresponding to a particular data block; and
prioritize restoration of the particular data block on the restore destination, before initiating the data restore process, or while the data restore process is in progress.

3. The system of claim 1, wherein the restore destination is at the same location as the primary data source, or at a different location from the primary data source.

4. The system of claim 1, wherein the state_{N} corresponds to a current state of the data on the primary data source, and the data restore module is configured to sequentially restore the data to the state_{RP}, based on the current state and the MMDBs corresponding to different back-up points between the recovery point and the current state.

5. The system of claim 1, wherein the state_{N} corresponds to a state closest to the state_{RP} and is different from a current state of the data on the primary data source, and the data restore module is configured to sequentially restore the data to the state_{RP}, based on a snapshotN corresponding to the state_{N} and the MMDBs corresponding to different back-up points between the recovery point and the point N.

6. The system of claim 1, wherein the log access module is configured to first attempt to access the log of MMDBs from the primary data source, and if the log of MMDBs is not available on the primary data source, the log access module is further configured to access the log of MMDBs from the data back-up server.

7. A system for selectively restoring data from a data back-up server, the system comprising:
a memory storing one or more processor-executable routines; and
a processor communicatively coupled to the memory, the processor configured to:
receive a recovery point (RP) as defined by a user;
access a state_{N} of the data from a primary data source at a point N;
access a log of modified meta-data and data blocks (MMDB), from the primary data source or the data back-up server, corresponding to a data back-up point previous to the point N; and
iteratively perform selective restore of the data, based on the state_{N} and the MMDB, from the data back-up server to a restore destination, until the data is restored to a state_{RP}, corresponding to the recovery point (RP).

8. The system of claim 7, wherein the processor is further configured to
copy top directory metadata corresponding to the state_{RP} to the restore destination,
receive a request from the user, based on a search on the copied top directory metadata in the restore destination, corresponding to a particular data block; and
prioritize restoration of the particular data block on the restore destination, before initiating the data restore process, or while the data restore process is in progress.

9. The system of claim 7 wherein the restore destination is at the same location as the primary data source, or at a different location from the primary data source.

10. The system of claim 7, wherein the state_{N} corresponds to a current state of the data on the primary data source, and the processor is configured to sequentially restore the data to the state_{RP}, based on the current state and the MMDBs corresponding to different back-up points between the recovery point and the current state.

11. The system of claim 7, wherein the state_{N} corresponds to a state closest to the state_{RP} and is different from a current state of the data on the primary data source to which the data needs to be restored, and the processor is configured to sequentially restore the data to the state_{RP}, based on a snapshotN corresponding to the state_{N} and the MMDBs corresponding to different back-up points between the recovery point and the point N.

12. The system of claim 7, wherein the processor is configured to first attempt to access the MMDB from the primary data source, and if the MMDB is not available on the primary data source, the processor is further configured to access the MMDB from the data back-up server.

13. The system of claim 7, wherein the processor is configured to iteratively perform selective restore of the data by:
(i) accessing a log of modified meta-data and data blocks (MMDBN-1), corresponding to a data back-up point N-1, from the primary data source or the data back-up server;
(ii) selectively restoring the data to state_{N-1}, based on the state_{N} and MMDB_{N-1}, from the data back-up server to the restore destination;
(iii) accessing a log of modified meta-data and data blocks (MMDB_{N-2}), corresponding to a data back-up point N-2, from the primary data source or the data back-up server;
(iv) selectively restoring the data to state_{N-2}, based on the state_{N-1} and MMDB_{N-2}, from the data back-up server to the restore destination; and
(v) iteratively repeating steps (iii) and (iv) until the data is restored to the state_{RP}, corresponding to the recovery point (RP), to the restore destination.

14. A method for selectively restoring data from a data back-up server, the method comprising:
receiving a recovery point (RP) as defined by a user;
accessing a state_{N} of the data from a primary data source at a point N;
accessing a log of modified meta-data and data blocks (MMDB), from the primary data source or the data back-up server, corresponding to a data back-up point previous to the point N; and
iteratively performing selective restore of the data, based on the state_{N} and the MMDB, from the data back-up server to a restore destination, until the data is restored to a state_{RP}, corresponding to the recovery point (RP).

15. The method of claim 14, further comprising:
copying top directory metadata corresponding to the state_{RP} to the restore destination,
receiving a request from the user, based on a search on the copied top directory metadata in the restore destination, corresponding to a particular data block; and
prioritizing restoration of the particular data block on the restore destination, before initiating the data restore process, or while the data restore process is in progress.

16. The method of claim 14, wherein the restore destination is at the same location as the primary data source, or at a different location from the primary data source.

17. The method of claim 14, wherein the state_{N} corresponds to a current state of the data on the primary data source, and the method comprises sequentially restoring the data to the state_{RP}, based on the current state and the MMDBs corresponding to different back-up points between the recovery point and the current state.

18. The method of claim 14, wherein the state_{N} corresponds to a state closest to the state_{RP} to which the data needs to be restored and is different from a current state of the data on the primary data source to which the data needs to be restored, and the method comprises sequentially restoring the data to the state_{RP}, based on a snapshot_{N} corresponding to the state_{N} and the MMDBs corresponding to different back-up points between the recovery point and the point N.

19. The method of claim 14, wherein the accessing the MMDB comprises first attempting to access the MMDB from the primary data source, and if the MMDB is not available on the primary data source, accessing the MMDB from the data back-up server.

20. The method of claim 14, wherein the step of iteratively performing selective restore of the data comprises:
accessing a log of modified meta-data and data blocks (MMDB_{N-1}), corresponding to a data back-up point N-1, from the primary data source or the data back-up server;
(ii) selectively restoring the data to stater-i, based on the stater and MMDB_{N-1}, from the data back-up server to the restore destination;
(iii) accessing a log of modified meta-data and data blocks (MMDB_{N-2}), corresponding to a data back-up point N-2, from the primary data source or the data back-up server;
(iv) selectively restoring the data to state_{N2}, based on the state_{N-1} and MMDB_{N-2}, from the data back-up server to the restore destination; and
(v) iteratively repeating steps (iii) and (iv) until the data is restored to the state_{RP}, corresponding to the recovery point (RP), to the restore destination.
